(19) United States
(12) Patent Application Publication
(10) Pub. No.: US 2010/0157841 A1
(43) Pub. Date: Jun. 24, 2010

(54) METHOD AND APPARATUS FOR DETERMINING BANDWIDTH REQUIREMENT FOR A NETWORK

(76) Inventors: SARAT PUTHENPURA, Berkeley Heights, NJ (US); David Belanger, Hillsborough, NJ (US); Sam Parker, Cranbury, NJ (US); Ravi Raina, North Brunswick, NJ (US); Wenjie Zhao, Princeton, NJ (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 12/338,690

(22) Filed: Dec. 18, 2008

(51) Int. Cl. H04L 12/26

(52) U.S. Cl. 370/253

(57) ABSTRACT

A method and apparatus for determining a bandwidth requirement for a network are disclosed. For example, the method gathers data for one or more types of traffic, and determines an optimal traffic model for each of the one or more types of traffic in accordance with the data and one or more traffic model adaptation rules for each of the one or more types of traffic. The method then determines a demand forecast for each of the one or more types of traffic by applying the optimal traffic model for each of the one or more types of traffic, and determines a bandwidth requirement for the one or more types of traffic in accordance with the demand forecast.

The present invention relates generally to communication networks and, more particularly, to a method and apparatus for determining or forecasting bandwidth requirement for a network, e.g., an access network such as a radio access network.

### BACKGROUND OF THE INVENTION

As Internet usage continues to grow, more and more customers are accessing communications services via a mobile device, e.g., a cell phone, a laptop computer, a Personal Digital Assistant (PDA), etc. For example, a customer may receive multimedia content via his/her cell phone. The cell phone transmits and receives voice and data packets to and from the service provider's network via a base station and an access network.

The customer's ability to access services via a wireless device is dependent on the availability of capacity in the nearby base station and the access network. The service provider may then forecast the demand for an access network and/or base station and deploy a network accordingly. However, the wireless network business is dynamic in nature. That is, as customers increase their mobility and change the type of services that they access, the demand prediction becomes increasingly unreliable. For example, the capacity of the access network and/or base station may be inadequate in some locations and excessive in other locations. Furthermore, the demand may change over time. For example, if a large number of customers subscribe to receive a streaming media (e.g., for a football game) via their respective cell phones, the base stations and/or access network may not have enough capacity set aside for streaming the requested media content. The customers may become dissatisfied with the service, and the service provider may experience reduced revenue and/or increased churn. One method to ensure that the capacity is adequate is to over-engineer the network. However, over-engineering the network increases the cost of the network and the customers may be dissatisfied with paying more for the service.

### SUMMARY OF THE INVENTION

In one embodiment, the present invention discloses a method and apparatus for determining a bandwidth requirement for a network, e.g. a radio access network. For example, the method gathers data for one or more types of traffic, and determines an optimal traffic model for each of the one or more types of traffic in accordance with the data and one or more traffic model adaptation rules for each of the one or more types of traffic. The method then determines a demand forecast for each of the one or more types of traffic by applying the optimal traffic model for each of the one or more types of traffic, and determines a bandwidth requirement for the one or more types of traffic in accordance with the demand forecast.

### BRIEF DESCRIPTION OF THE DRAWINGS

The teaching of the present invention can be readily understood by considering the following detailed description in conjunction with the accompanying drawings, in which:

FIG. 1 illustrates an illustrative network related to the present invention;

FIG. 2 illustrates an illustrative network of the current invention for determining bandwidth requirement for a network;

FIG. 3 illustrates a flowchart of a method for determining bandwidth requirement for a network; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for determining or forecasting bandwidth requirement for a network, e.g., an access network such as a radio access network. Although the present invention is discussed below in the context of a radio access network, the present invention is not so limited. Namely, the present invention can be applied for other types of networks wherein traffic may be backhauled to a switching office or routing office.

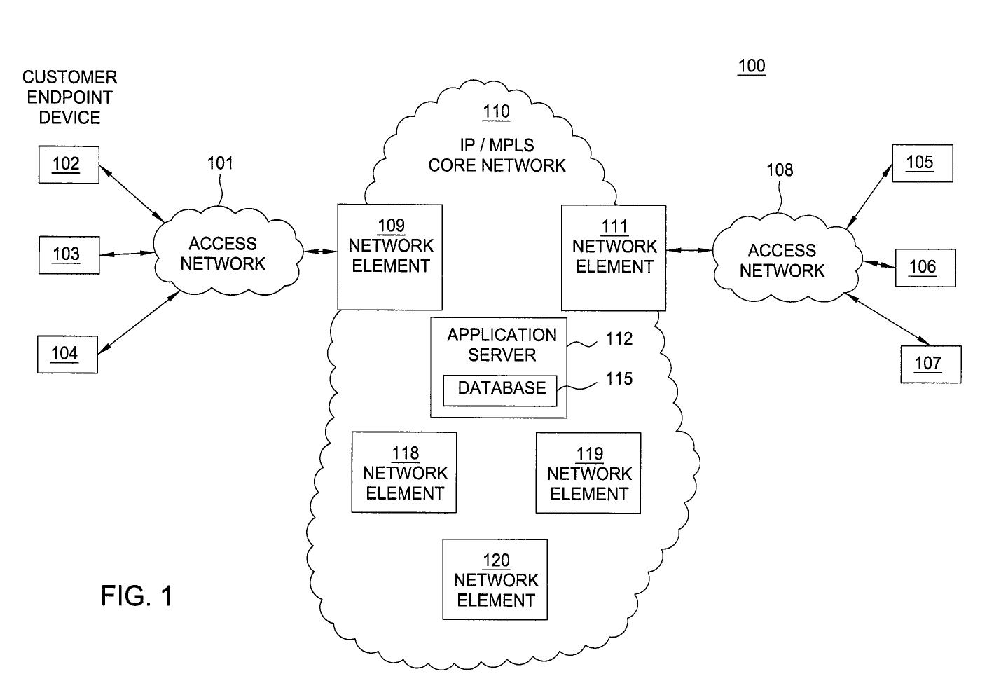

FIG. 1 is a block diagram depicting an illustrative packet network 100 related to the current invention. Illustrative packet networks may include Internet protocol (IP) networks, Ethernet networks, and the like. An IP network is broadly defined as a network that uses Internet Protocol such as IPv4 or IPv6 and the like to exchange data packets.

In one embodiment, the packet network may comprise a plurality of endpoint devices 102-104 configured for communication with the core packet network 110 (e.g., an IP based core backbone network supported by a service provider) via an access network 101. Similarly, a plurality of endpoint devices 105-107 are configured for communication with the core packet network 110 via an access network 108. The network elements 109 and 111 may serve as gateway servers or edge routers for the network 110.

The endpoint devices 102-107 may comprise customer endpoint devices such as personal computers, laptop computers, Personal Digital Assistants (PDAs), servers, routers, wireless phones, and the like. The access networks 101 and 108 serve as a means to establish a connection between the endpoint devices 102-107 and the NEs 109 and 111 of the IP/MPLS core network 110. The access networks 101 and 108 may each comprise a Digital Subscriber Line (DSL) network, a broadband cable access network, a Local Area Network (LAN), a Wireless Access Network (WAN), a Radio Access Network (RAN), a 3^{rd} party network, and the like. The access networks 101 and 108 may be either directly connected to NEs 109 and 111 of the IP/MPLS core network 110, or indirectly through another network.

Some NEs (e.g., NEs 109 and 111) reside at the edge of the core infrastructure and interface with customer endpoints over various types of access networks. An NE that resides at the edge of a core infrastructure can be implemented as an edge router, a media gateway, a border element, a firewall, a switch, and the like. An NE may also reside within the network (e.g., NEs 118-120) and may be used as a mail server, a router, or like device. The IP/MPLS core network 110 also comprises an application server 112 that contains a database 115. The application server 112 may comprise any server or computer that is well known in the art, and the database 115 may be any type of electronic collection of data that is also well known in the art. Those skilled in the art will realize that although only six endpoint devices, two access networks, five network elements and so on are depicted in FIG. 1, the communication system 100 may be expanded by including additional endpoint devices, access networks, network elements, and/or application servers, without altering the present invention. The above IP network is described to provide an illustrative environment in which packets for various services, e.g., voice and data services, are transmitted on networks.

In one embodiment, a service provider may enable customers to access services via a wireless access network. For example, a customer may use a cell phone to access Internet Protocol (IP) services, e.g., Voice over Internet Protocol (VoIP) services, multimedia services, Service over Internet Protocol (SoIP) services, and the like. The packets from and to the cell phone may then traverse one or more access networks and a base station between the cell phone and the IP network. The service provider may implement the one or more access networks and base stations based on a demand forecast. However, due to the dynamic nature of wireless service usage, it is difficult to provide an accurate demand forecast. In order to accommodate the changing demand pattern, the service provider may have to over-engineer the access network. Unfortunately, an over-engineered network is very costly and wasteful of resources.

In one embodiment, the current invention determines or forecasts a bandwidth requirement for a network, e.g., an access network such as a radio access network. The service provider first establishes performance metric and adaptable traffic models (described below) for various types of traffic. For example, the network traffic may comprise voice traffic, data traffic, video traffic, and the like. Each type of traffic may have different performance criteria (e.g., broadly including but not limited to: call blocking rate, drop call rate, loss packet rate, throughput rate, packet delay, and the like) and different traffic models. The performance criteria may then be placed in a matrix format, establishing performance metrics for each type of traffic. In one embodiment, the performance criteria for voice packets may be provided in terms of blocking probabilities while the performance criteria for data packets may be provided in terms of delay, throughput, etc.

A traffic model refers to a mathematical formula that may be used to characterize a traffic pattern. For example, a traffic model may relate an arrival rate for a specific type of traffic and the number of servers available to handle the arriving packets for the specific type of traffic to a blocking rate (blocking probability) for the specific type of traffic. For example, if the traffic type is voice, the model may relate the arrival rate of voice traffic and the number of resources handling voice traffic, to a blocking rate of voice calls in the network. In one embodiment, the current method may use different traffic models for voice packets, data packets, streaming media packets, and the like.

In one embodiment, the current method uses traffic models that comprise one or more of: an Erlang-B model, a Kaufman-Roberts model, and an M/G/1 queuing model. For example, the Erlang-B model refers to a mathematical model in which a blocking probability B, a number of available resources N, and a traffic volume measurement A in Erlangs (number of call-hours in busy hour) are related by the formula:

$$B ( N , A ) = \frac{\frac{{A}^{N}}{N !}}{{\sum }_{i = 0}^{N} \frac{{A}^{i}}{i !}} .$$

A Kaufman-Roberts model refers to a mathematical model, e.g., as defined in J. S. Kaufman, “Blocking in a Shared Resource Environment”, IEEE Transactions on Communications, Vol. COM-29, No. 10, October 1981, pp. 1474-1481. An M/G/1 queuing model refers to a mathematical model for traffic that has: (1) a Poisson arrival process, (2) a statistical distribution for service time that follows any general function, (3) and one server. For example, the voice traffic at a specific time may be modeled using an Erlang-B formula while the data traffic may be modeled using an M/G/1 queuing model.

The service provider also establishes traffic model adaptation rules based on criteria that comprise one or more of: performance metric, current traffic pattern, pricing rule, and market forecast. The traffic model adaptation rules may be used for selecting a traffic model (e.g. among the above models) and/or one or more parameter values for each type of traffic at a specific time.

In one example, the traffic model adaptation rules are provided in terms of demand and performance metrics for a traffic type at a specific time period. For example, the adaptation rule may be provided mathematically as follows:

Let, d[i,t] represent demand for traffic type i at time period t,
wherein i=1, 2, . . . , n and t=1, 2, . . . , T; and

Let, also m[i,j] represent performance metric j for traffic type i,
wherein i=1, 2, . . . , n, j=1, 2, . . . , J[i], J[i]=Total number of metrics for traffic type I.

Then, a traffic model adaptation rule may be specified as a function of d[i,t] and m[i,j]. Specifically, let k[i,t] represent an index for an optimal model to be used for traffic type i at time period t, wherein k[i,t]=1, 2, . . . , M. Then, k[i,t]=F(i,d[1,t],d[2,t], . . . , d[n,t],m[1,1],m[1,2], . . . , m[1,J[1]], . . . , m[n,1],m[n,2], . . . , m[n,J[n]]).

The function F is a discrete function. In one embodiment, the definition for F is provided as a series of if else statements. For example, a user interface to a rule engine may enable users to define a set of rules for defining the function F. Table 1 provides an example of a set of illustrative rules for defining the function F. When multiple rules apply for a given situation, the method also provides a rule salience that determines the priority. For example, a rule salience may provide which rule prevails if the conditions are met for two or more rules.

TABLE 1

| Rule | |
|---|---|
| Number | Rule |
| 1 | If d[1, t] > 25 and m[1, 1] < 0.00005 and |
| | sum(d[2, t], d[3, t], . . . , d[n, t]) < 140, |
| | then k[1, t] = 1 |
| 2 | If d[1, t] < 30 and m[1, 1] > 0.0001 and |
| | sum(d[2, t], d[3, t], . . . , d[n, t]) > 100, then |
| | k[1, t] = 2 |
| 3 | If d[3, t] > 50 and m[3, 1] > 4 and |
| | d[1, t] < 30 and d[2, t] < 4, then k[1, t] = 5 |

For illustration of rule 1, suppose traffic type 1 is voice, time period is 1, and performance metric 1 (for voice) is a blocking rate. If, during period 1, the demand for voice calls is 35, the demand for all other calls is 100, and the blocking rate for voice calls is 0.00001, then rule 1 is applicable. That means k[1,t]=1, provided there are no other applicable rules of higher priority. Hence, the optimal traffic model to be used for the voice traffic at time period 1 is then the model that is represented by the index 1.

The method provides a rule engine in an application server that performs traffic model adaptations in accordance with the traffic model adaptation rules. For the example above, the rule engine may determine a value for k[i,t] that identifies the optimal model to be used for the traffic type i at time period t. For instance, if index 1 represents an M/G/1 model, the current method selects the M/G/1 model as the optimal model. In another example, if index 1 represents an Erlang-B model, the method selects the Erlang-B model as the optimal model.

The method may then apply the optimal model for each traffic type and determine a demand forecast. For example, if the optimal model for voice traffic at a specific time period is found to be an Erlang-B formula, then the voice traffic is modeled using the Erlang-B formula for a predetermined performance level (e.g. blocking probability) and traffic volume (e.g. number of call-hours in busy hour and the like). A demand for a future time may then be forecasted based on the optimal model.

The method may then forecast bandwidth requirements for an access network and/or base stations based on the demand forecast, performance metrics for the various traffic types and/or other factors (e.g., market conditions, marketing campaigns, etc). For example, the method may determine a bandwidth requirement for a cell site (e.g., a base station) and the access network used for transporting the packets from the cell site to a switching office. The service provider may then use the bandwidth requirements and network design rules for providing network growth and capital projections.

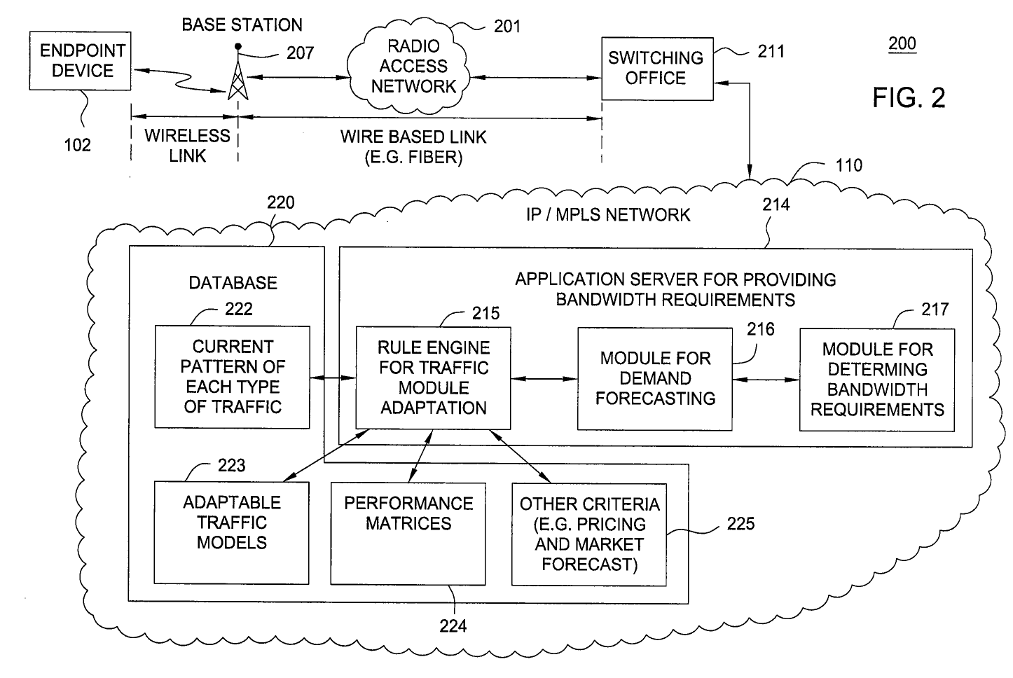

FIG. 2 illustrates an illustrative network 200 in accordance with the current invention for determining a bandwidth requirement for a network. The illustrative network 200 comprises a wireless customer endpoint device 102 communicating with an IP network 110 via a base station 207, a radio access network 201 and a switching office 211. The link between the customer endpoint device 102 and the base station 207 is a wireless link. The link between the base station 207 and the switching office 211 through the radio access network 201 is wire based link, e.g., a fiber optic line. The IP network 110 may include an application server 214 for determining bandwidth requirements for access networks and/or base stations, and a database 220. The database 220 comprises various storage modules for storing: a current pattern of each type of traffic 222, adaptable traffic models 223, performance metrics 224, and other criteria 225 (e.g., pricing and market forecasts). In one embodiment, the application server 214 may comprise: a rule engine for traffic model adaptation 215, a module for demand forecasting 216, and a module for determining bandwidth requirements 217. The rule engine for traffic model adaptation 215 is connected to the database 220 and the module for demand forecasting 216. The module for demand forecasting 216 is also connected to the module for determining the bandwidth requirements.

In one embodiment, the rule engine for traffic model adaptation 215 contains the adaptation rules established by the service provider for use in determining an optimal traffic model for a traffic type at a specific time from among the various adaptable traffic models 223. For example, a traffic model adaptation rule can be applied for selecting an optimal model for voice traffic based on criteria that comprise one or more of: voice traffic performance metrics, current voice traffic pattern, voice service pricing rules and market forecast. Thus, the rule engine for traffic model adaptation is used for selecting an optimal traffic model and/or one or more parameter values for the traffic model.

In one embodiment, the module for demand forecasting 216 applies the optimal traffic model and determines a demand forecast for each traffic type. For example, if the optimal model for voice traffic at a specific time period is found to be an Erlang-B formula, the voice traffic is modeled using the Erlang-B formula for a predetermined performance level (e.g., blocking probability) and traffic volume (e.g., number of call-hours in busy hour). The demand forecast may then be based on the Erlang-B model. The module for determining the bandwidth requirements 217 may then determine the bandwidth requirements for an access network and/or one or more base stations based on the demand forecast.

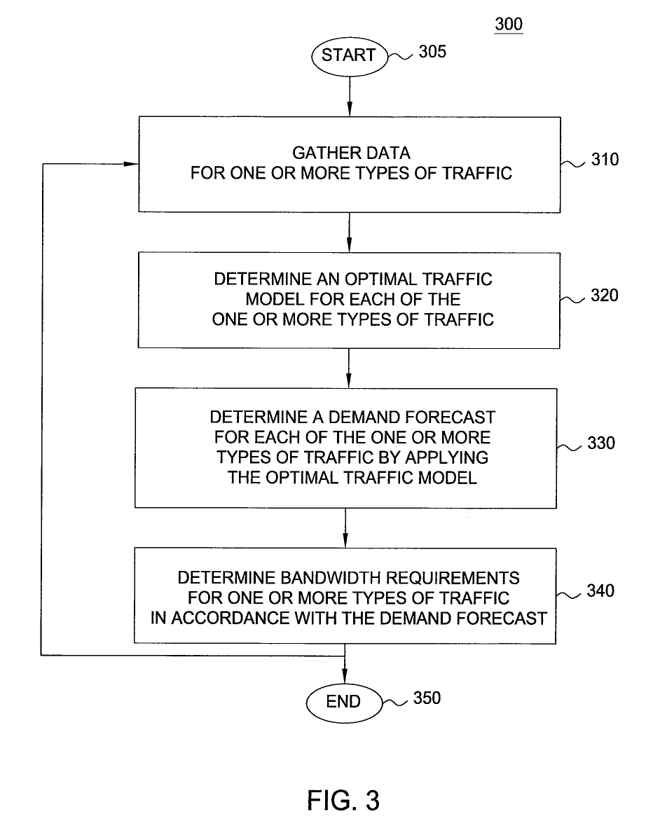

FIG. 3 illustrates a flowchart of a method 300 for determining a bandwidth requirement for a network. Method 300 starts in step 305 and proceeds to step 310.

In step 310, method 300 gathers data, e.g., in real time, for one or more types of traffic. For example, the method may gather blocking rates, current call volume, and the like for voice traffic. In another example, the method may gather throughput, packet loss rate, and the like for data traffic. In one embodiment, the data may comprise one or more of: a current traffic pattern, one or more performance metrics, one or more pricing rules, or a market forecast.

In step 320, method 300 determines an optimal traffic model for each of the one or more types of traffic in accordance with the gathered data and the one or more traffic model adaptation rules for each of the one or more types of traffic. For example, the rule engine may identify an optimal traffic model for each of the one or more types of traffic (e.g., voice traffic, data traffic, streaming video traffic, etc.).

In step 330, method 300 determines a demand forecast for each of the one or more types of traffic by applying the optimal traffic model for each of the one or more types of traffic. For example, if the optimal traffic model for voice traffic is an Erlang-B model, the method applies the Erlang-B model to determine the demand forecast for voice traffic.

In step 340, method 300 determines bandwidth requirements for the one or more types of traffic in accordance with the demand forecast. For example, the access network and base station bandwidth may have to increase/decrease to support the associated increase/decrease in the demand forecast. For example, there may be increasing demand for streaming media while there may be decreasing demand for voice traffic based upon the calculated demand forecasts. Thus, the service provider will be able to adjust the bandwidth requirements to allocate more capacity for the streaming media traffic and less capacity for the voice traffic. The method then ends in step 350 or returns to step 310 to continue gathering more data.

Those skilled in the art would realize that the service providers for providing the cellular service, for providing multimedia content on a mobile media center and/or for providing access management of the multimedia content server may be the same or different service providers. Thus, the above exemplary network is not intended to limit the implementation to any number of service providers.

It should be noted that although not specifically specified, one or more steps of method 300 may include a storing, displaying and/or outputting step as required for a particular application. In other words, any data, records, fields, and/or intermediate results discussed in the method 300 can be stored, displayed and/or outputted to another device as required for a particular application. Furthermore, steps or blocks in FIG. 3 that recite a determining operation, or involve a decision, do not necessarily require that both branches of the determining operation be practiced. In other words, one of the branches of the determining operation can be deemed as an optional step.

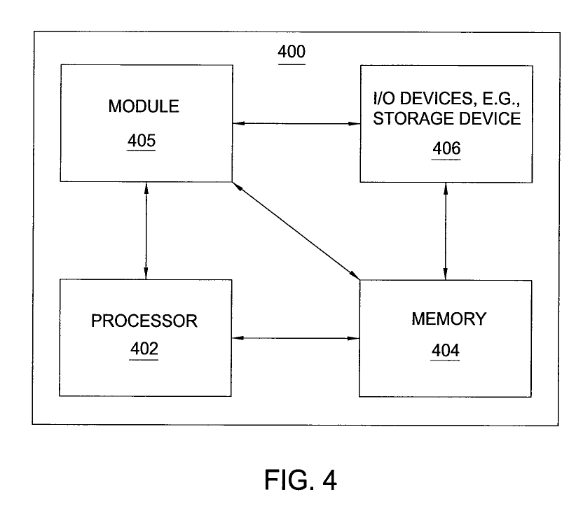

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for determining a bandwidth requirement for a network, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 405 for determining a bandwidth requirement for a network can be loaded into memory 404 and executed by processor 402 to implement the functions as discussed above. As such, the present method 405 for determining a bandwidth requirement for a network (including associated data structures) of the present invention can be stored on a computer readable medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for determining a bandwidth requirement for a network, comprising:
gathering data for one or more types of traffic;
determining an optimal traffic model for each of said one or more types of traffic in accordance with said data and one or more traffic model adaptation rules for each of said one or more types of traffic;
determining a demand forecast for each of said one or more types of traffic by applying said optimal traffic model for each of said one or more types of traffic; and
determining a bandwidth requirement for said one or more types of traffic in accordance with said demand forecast.

2. The method of claim 1, wherein said data comprises one or more of: a performance criterion, a pricing rule, or a market forecast.

3. The method of claim 1, wherein said optimal traffic model for each of said one or more types of traffic comprises: an Erlang-B model, a Kaufman-Roberts model, or an M/G/1 queuing model.

4. The method of claim 1, wherein said one or more traffic model adaptation rules are provided in terms of one or more of: a demand, or a performance metric for each of said one or more types of traffic.

5. The method of claim 4, wherein said one or more traffic model adaptation rules are provided for a specific time period.

6. The method of claim 1, wherein said one or more traffic model adaptation rules are specified as a function.

7. The method of claim 6, wherein said function is a discrete function that comprises a series of one or more if else statements.

8. The method of claim 7, wherein said function further comprises a rule salience that determines a priority of said series of one or more if else statements.

9. A computer-readable medium having stored thereon a plurality of instructions, the plurality of instructions including instructions which, when executed by a processor, cause the processor to perform steps of a method for determining a bandwidth requirement for a network, comprising:
gathering data for one or more types of traffic;
determining an optimal traffic model for each of said one or more types of traffic in accordance with said data and one or more traffic model adaptation rules for each of said one or more types of traffic;
determining a demand forecast for each of said one or more types of traffic by applying said optimal traffic model for each of said one or more types of traffic; and
determining a bandwidth requirement for said one or more types of traffic in accordance with said demand forecast.

10. The computer-readable medium of claim 9, wherein said data comprises one or more of: a performance criterion, a pricing rule, or a market forecast.

11. The computer-readable medium of claim 9, wherein said optimal traffic model for each of said one or more types of traffic comprises: an Erlang-B model, a Kaufman-Roberts model, or an M/G/1 queuing model.

12. The computer-readable medium of claim 9, wherein said one or more traffic model adaptation rules are provided in terms of one or more of: a demand, or a performance metric for each of said one or more types of traffic.

13. The computer-readable medium of claim 12, wherein said one or more traffic model adaptation rules are provided for a specific time period.

14. The computer-readable medium of claim 9, wherein said one or more traffic model adaptation rules are specified as a function.

15. The computer-readable medium of claim 14, wherein said function is a discrete function that comprises a series of one or more if else statements.

16. The computer-readable medium of claim 15, wherein said function further comprises a rule salience that determines a priority of said series of one or more if else statements.

17. An apparatus for determining a bandwidth requirement for a network, comprising:
means for gathering data for one or more types of traffic;
means for determining an optimal traffic model for each of said one or more types of traffic in accordance with said data and one or more traffic model adaptation rules for each of said one or more types of traffic;
means for determining a demand forecast for each of said one or more types of traffic by applying said optimal traffic model for each of said one or more types of traffic; and
means for determining a bandwidth requirement for said one or more types of traffic in accordance with said demand forecast.

18. The apparatus of claim 17, wherein said data comprises one or more of:
a performance criterion, a pricing rule, or a market forecast.

19. The apparatus of claim 17, wherein said optimal traffic model for each of said one or more types of traffic comprises: an Erlang-B model, a Kaufman-Roberts model, or an M/G/1 queuing model.

20. The apparatus of claim 17, wherein said one or more traffic model adaptation rules are provided in terms of one or more of: a demand, or a performance metric for each of said one or more types of traffic.
